(19) United States
(12) Patent Application Publication
(10) Pub. No.: US 2013/0119032 A1
(43) Pub. Date: May 16, 2013

(54) SYSTEM AND METHOD FOR WELDING MATERIALS OF DIFFERENT CONDUCTIVITY

(71) Applicants: Geoffrey M Lipnevicius, Sagamore Hills, OH (US); Brian Simons, Willoughby, OH (US)

(72) Inventors: Geoffrey M Lipnevicius, Sagamore Hills, OH (US); Brian Simons, Willoughby, OH (US)

(73) Assignee: LINCOLN GLOBAL, INC., City of Industry, CA (US)

(21) Appl. No.: 13/294,582

(22) Filed: Nov. 11, 2011

(51) Int. Cl. B23K 9/095

(52) U.S. Cl. 219/124.1

(57) ABSTRACT

An arc welding system for welding materials of different electric conductivity has a robotic arm and a welding torch with a nozzle, disposed on a first end of the robotic arm, for applying an amperage to a wire supply at the nozzle. The arc welding system has a controller for controlling direction and speed of movement of the robotic arm and for controlling the amperage applied by the welding torch.

### FIELD OF INVENTION

The present disclosure relates to the field of arc welding. More particularly, the present disclosure relates to a system and method for arc welding a first material to a second material having different conductivity.

### BACKGROUND

Arc welding is a technique used to join two metals together. A welding torch applies an electric current to the metals at a seam in order to heat and melt the metals. As the metals cool, they combine to form a joint. Arc welding two different types of metals, such as copper and steel, presents a challenge, however. Specifically, the two metals may have different properties, including different heat conductivity and different electric conductivity. Thus, the electric current applied to heat the metals must be constantly adjusted, as the welding torch moves between metals, in order to compensate for the different properties to ensure a reliable weld. This is a slow, manual process that requires a skilled operator. An operator may move the welding torch along the seem at six inches per minute, for example. As a result, arc welding two different metals having different conductivity can be an expensive and time consuming process.

Brazing may be used to join two different metals together more efficiently. Specifically, since brazing two metals together does not require melting the two metals, the brazing process will not change as a result of the two metals having different conductivity. Joints produced by brazing, however, may not be as reliable as joints produced by arc welding.

### SUMMARY OF THE INVENTION

An arc welding system for welding materials of different electric conductivity has a robotic arm and a welding torch with a nozzle disposed on a first end of the robotic arm, for applying an amperage to a wire supply at the nozzle. The arc welding system has a controller for controlling direction and speed of movement of the robotic arm and for controlling the amperage applied by the welding torch. The controller has one or more processors, one or more computer-readable tangible storage devices, and program instructions stored on at least one of the one or more storage devices for execution by at least one of the one or more processors. The program instructions include program instructions configured to cause the robotic arm to move the first end in a first direction along a seam between a first base material having a first electric conductivity and a second base material having a second electric conductivity, different from the first electric conductivity. The program instructions include program instructions configured to cause the robotic arm to oscillate the first end between a first region proximate to the first base material and a second region proximate to the second base material. The program instructions include program instructions configured to cause the welding torch to apply a first amperage to the wire supply when the first end of the robotic arm is proximate to the first region, and to apply a second amperage, different from the first amperage, to the wire supply when the first end of the robotic arm is proximate to the second region.

In a method for welding materials of different electric conductivity, a computer instructs a robotic arm comprising a welding torch to move the welding torch in a first direction along a seam between a first base material having a first electric conductivity and a second base material having a second electric conductivity, different from the first electric conductivity. The computer instructs the robotic arm to oscillate the welding torch between a first region proximate the first base material and a second region proximate the second base material. The computer causes the welding torch to apply a first amperage to a wire supply when the welding torch is in the first region, and to apply a second amperage, different from the first amperage, to the wire supply when the welding torch is in the second region.

An apparatus for welding materials of different electric conductivity has a robotic arm. The apparatus has a welding torch with a nozzle, disposed on a first end of the robotic arm, for applying an amperage to a wire supply at the nozzle. The apparatus has movement means to move the first end in a first direction along a seam between a first base material having a first electric conductivity and a second base material having a second electric conductivity different from the first electric conductivity. The apparatus has oscillating means to oscillate the first end between a first region proximate to the first base material and a second region proximate to the second base material. The apparatus has amperage means to apply a first amperage, via the welding torch, to the wire supply when the first end of the robotic arm is proximate to the first region, and to apply a second amperage, different from the first amperage, via the welding torch, to the wire supply when the first end of the robotic arm is proximate to the second region.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 illustrates an example arc welding system for welding materials of different conductivity

FIG. 2 is a block diagram of the controller of the are welding system of FIG. 1.

FIG. 3 is a flow chart illustrating an example method for welding materials of different conductivity.

FIG. 4 is a block diagram of an example computing device for implementing an example controller of an arc welding system.

### DETAILED DESCRIPTION

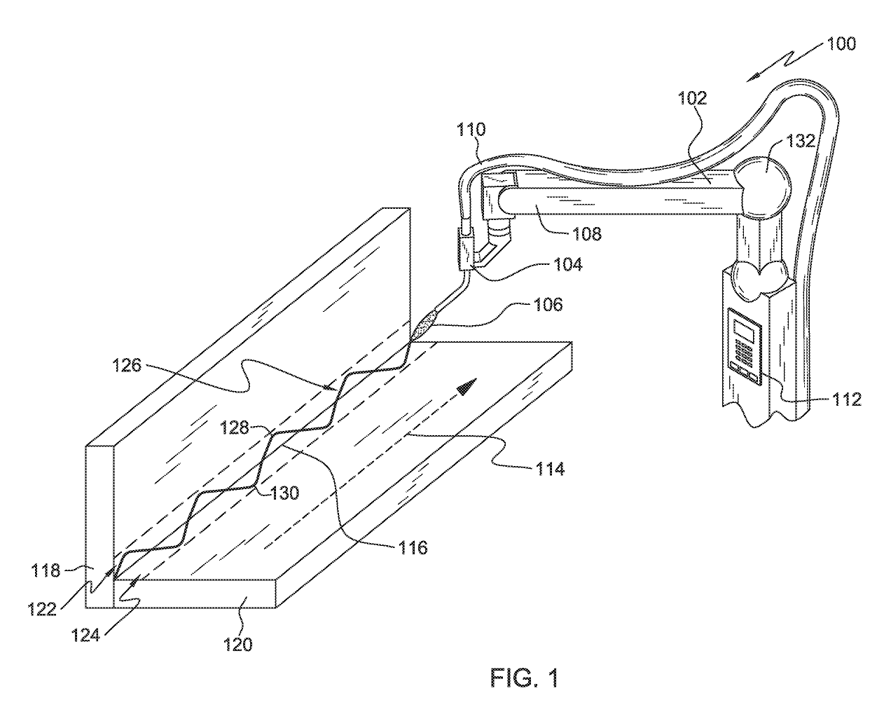

FIG. 1 is an arc welding system 100 for welding materials of different conductivity. Arc welding system 100 has a robotic arm 102 that rotates about joint 132, giving first end 108 a full range of motion in a three dimensional space. Arc welding system 100 has a welding torch 104 for applying an amperage to a wire supply 110 at a nozzle 106. Welding torch 104 is disposed on first end 108 of robotic arm 102, thereby enabling welding torch 104 to move in the three dimensional space along with robotic arm 102.

Arc welding system 100 has a controller 112 for controlling the direction and speed of movement of robotic arm 102. Controller 112 also controls the amperage welding torch 104 applies to wire supply 110. Thus, controller 112 is able to automatically adjust the operation of robotic arm 102 and welding torch 104, based on parameters defined by an operator, when performing a weld on materials of different conductivity. For example, when performing a weld on a first material 118 having a first electric conductivity, such as copper, and a second material 120 having a second conductivity, such as steel, controller 112 is able to direct robotic arm 102 to move in a first direction 114 along seam 116 between first material 118 and second material 118.

Controller 112 is also able to direct robotic arm 102 to oscillate first end 108 between a first region 122 at first base material 118 and second region 124 at second base material 120. In an example embodiment, controller 112 is able to direct robotic arm 102 to move in first direction 114 along seam 116 and to oscillate first end 108 between first region 122 and second region 124 simultaneously. In other words, controller 112 is able to direct robotic arm to weave or to move in a weave pattern 126, creating a series of peaks 128 and troughs 130.

In an example embodiment, controller 112 is configured to execute HeatWave weld process control software by FANUC Robotics America Inc., a known software for controlling amperage and speed of a welding torch when welding two materials of different thickness.

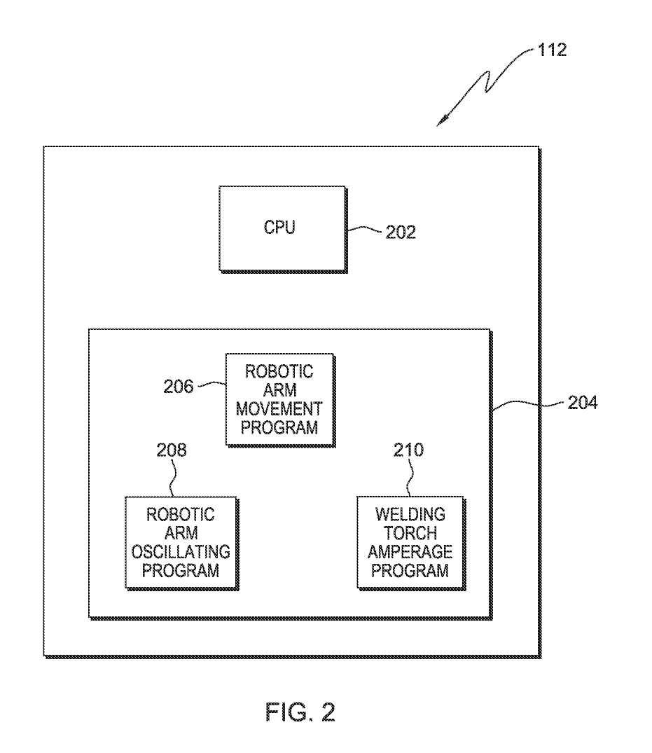

FIG. 2 is a block diagram of controller 112 of arc welding system 100 of FIG. 1. Controller 112 has a processor 202 for executing programs stored on tangible storage device 204. Tangible storage device 204 may be a computer readable medium such as a floppy disk drive, a hard disk drive, an optical disk drive, a tape device, a flash memory, or other solid state memory device.

Controller 112 has a robotic arm movement program 206 for causing robotic arm 102 to move welding torch 104 along seam 116 between two materials of different conductivity. Robotic arm program 206 is able to control the speed at which robotic arm 102 moves. For example, robotic arm program 206 may instruct robotic arm 102 to move at a speed of between 15 and 30 inches per minute (IPM).

Controller 112 has a robotic arm oscillating program 208 for causing robotic arm 102 to oscillate first end 108 between first region 122 and second region 124. Robotic arm oscillating program 208 can control the frequency at which robotic arm 102 oscillates. For example, robotic arm oscillating program 208 may cause robotic arm 102 to oscillate at a frequency of 15 Hz. Robotic arm oscillating program 208 can also control the amplitude of the oscillation. For example robotic arm oscillating program 208 may cause robotic arm 102 to oscillate at an amplitude of 0.3 mm.

In an exemplary embodiment, robotic arm movement program 206 causes robotic arm 102 to move welding torch 104 along seam 116 at the same time that robotic arm oscillating program 208 causes robotic arm 102 to oscillate. This results in robotic arm 102 moving along seam 116 in a weave pattern having peaks 128 in first region 122 and troughs 130 in second region 124. In an exemplary embodiment, robotic arm movement program 206 causes robotic arm 102 to oscillate smoothly, without delay, between peaks 128 and troughs 130. In an exemplary embodiment, robotic arm movement program 206 causes robotic arm 102 to pause, or dwell, at peaks 128 and at troughs 130. Robotic arm movement program 206 may cause robotic arm 102 to dwell at peaks 128 longer than at troughs 130. For example, robotic arm movement program may cause robotic arm 102 to dwell at peaks 128 for 0.4 seconds and may cause robotic arm 102 to dwell at troughs 130 for 0.1 seconds. Similarly, robotic arm movement program 206 may cause robotic arm 102 to dwell at troughs 130 longer than at peaks 128.

Controller 112 has a welding torch amperage program 210 for causing welding torch 104 to apply a first amperage to wire supply 110 when first end 108 of robotic arm 102 is in first region 122 and to apply a second amperage to wire supply 110, different from the first amperage, when first end 108 of robotic arm 102 is in second region 124.

In an exemplary embodiment, welding torch amperage program 210 may cause welding torch 104 to apply the first amperage to wire supply 110 when first end 108 of robotic arm 102 reaches peaks 128 and may cause welding torch 104 to apply the second amperage to wire supply 110 when first end 108 of robotic arm 102 reaches troughs 130. In other words, welding torch 104 does not apply an amperage to wire supply 110 along the entire path as welding torch 104 moves from peaks 128 to troughs 130.

In an exemplary embodiment, welding torch amperage program 210 may cause welding torch 104 to gradually change the amperage applied by welding torch 104 as robotic arm 102 moves from peaks 128 to troughs 130 such the amperage reaches the first amperage when robotic arm 102 reaches peaks 128. Similarly, welding torch amperage program 210 may cause welding torch to gradually change the amperage applied by welding torch 104 as robotic arm 102 moves from troughs 130 to peaks 128 such that amperage reaches the second amperage when robotic arm 102 reaches troughs 130. In other words, welding torch 104 applies amperage to wire supply 110 along the entire path as welding torch 104 moves from peaks 128 to troughs 130 and back to peaks 128.

In an example embodiment, welding torch amperage program 210 may cause welding torch 104 to change the wire feed speed (WFS). Specifically, welding torch amperage program 210 may cause welding torch 104 to feed wire supply 110 to nozzle 106 at a first speed when welding torch 104 is in first region 122 and to cause welding torch 104 to feed wire supply 110 to nozzle 106 at a second speed when welding torch 104 is in second region 124. For example, welding torch amperage program 219 may cause welding torch 104 to feed wire supply 110 to nozzle 106 at 125 IPM when welding torch 104 is in first region 122 and to cause welding torch 104 to feed wire supply 110 to nozzle 106 at 235 IPM when welding torch 104 is in second region 124.

It should be understood that although FIG. 2 depicts controller 112 having a single processor 202 and a single tangible storage device 204, controller may also have more then one processor (not shown) and more then one tangible storage device not shown).

It should be further understood that although the example arc welding system 100 has been described to include controller 112, arc welding system may alternatively include a laptop, a desktop computer, handheld computer, a tablet computer, a server, or another similar type of computing devices, capable of executing robotic arm movement program 206, robotic arm oscillating program 208, and welding torch amperage program 210.

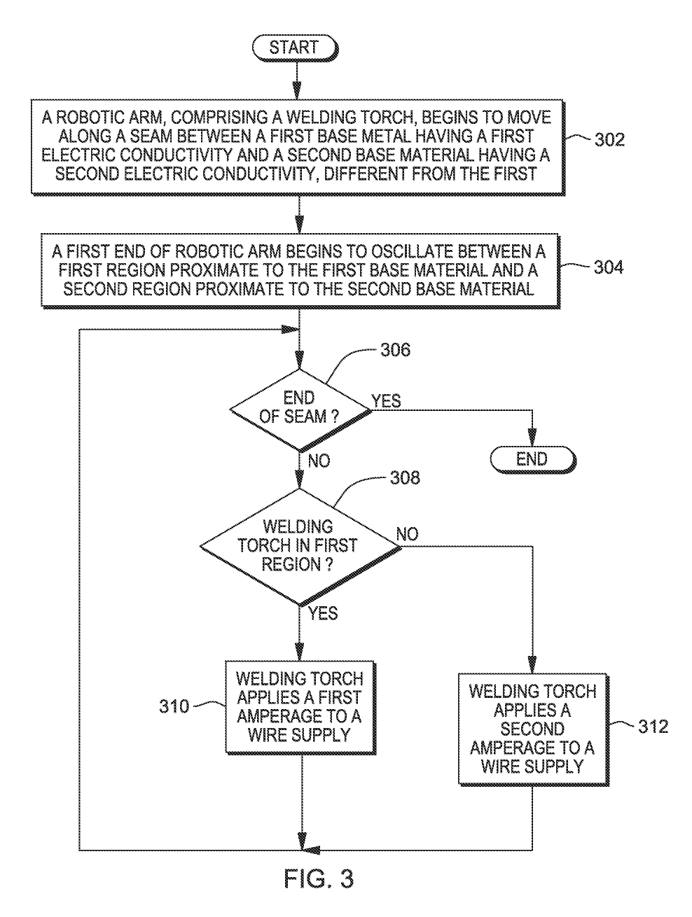

FIG. 3 is a flow chart illustrating an example method for welding materials of different conductivity. At step 302, controller 112 causes robotic arm 102, having a welding torch 104 at a first end 108, to begin moving along seem 116 between first base material 118 having a first electric conductivity and second base material 120 having a second electric conductivity, different from the first base material.

At step 304, controller 112 causes robotic arm 102 to begin to oscillate first end 108 between first base material 118 and second base material 120. Controller 112 continues to cause robotic arm 102 to oscillate and move along seem 116 until welding torch 104 reaches the end of seem 116.

While welding torch 104 has not yet reached the end of seen 116 (decision 306, no branch), controller 112 determines, at step 308, whether welding torch 104 is in first region 122 of first base material 118. If controller 112 determines that welding torch 104 is in first region 122 (decision 308, yes branch), then controller 112 causes welding torch 104 to apply a first amperage to a wire supply 110 at step 310. If controller 112 determines that welding torch 104 is not in first region 122 (decision 308, no branch), then controller 112 causes welding torch 104 to apply a second amperage to the wire supply 110 at step 312.

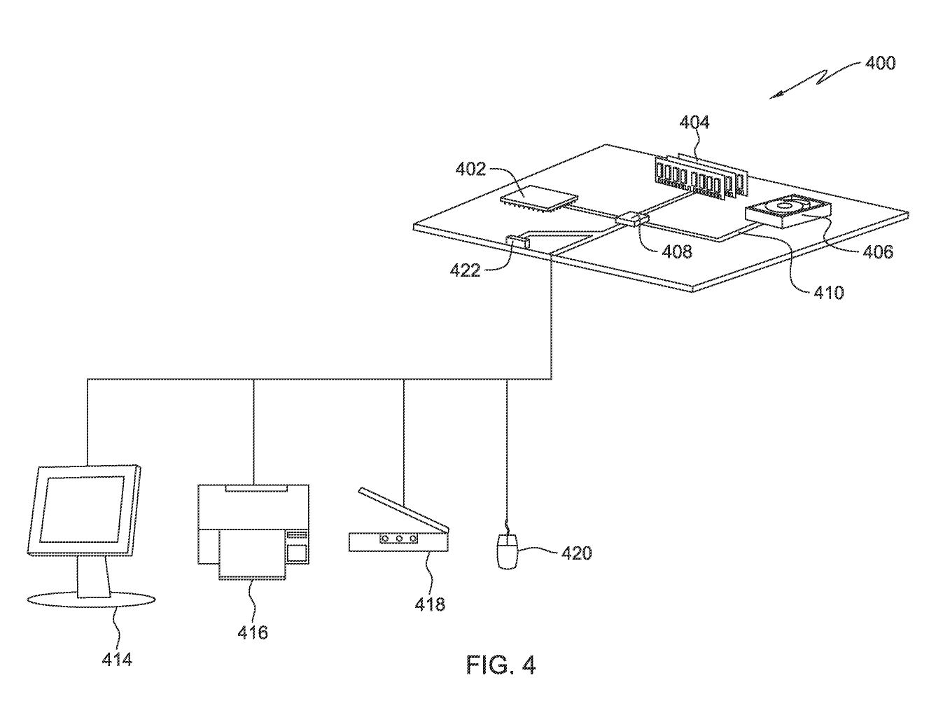

FIG. 4 is a block diagram of an example computer system 400 for controlling direction and speed of movement of the robotic arm and for controlling the amperage applied by the welding torch. Computer system 400 is intended to represent various forms of digital computers, including laptops, desktops, handheld computers, tablet computers, servers, and other similar types of computing devices. Computer system 400 includes a processor 402, memory 404, a storage device 406, and a communication port 422, connected by an interface 408 via a bus 410.

Storage device 406 stores robotic arm movement program 206, robotic arm oscillating program 208, and welding torch amperage program 210.

Processor 402 processes instructions, via memory 404, for execution within computer system 400, including robotic arm movement program 206, robotic arm oscillating program 208, and welding torch amperage program 210 stored on storage device 406. In an example embodiment, multiple processors along with multiple memories may be used. In an example embodiment, multiple computer systems 400 may be connected, with each device providing portions of the necessary operations.

Memory 404 may be volatile memory or non-volatile memory. Memory 404 may be a computer-readable medium, such as a magnetic disk or optical disk. Storage device 406 may be a computer-readable medium, such as floppy disk devices, a hard disk device, and optical disk device, a tape device, a flash memory, or other similar solid state memory device, or an array of devices, including devices in a storage area network of other configurations. A computer program product can be tangibly embodied in a computer readable medium such as memory 404 or storage device 406. The computer program product may contain robotic arm movement program 206, robotic arm oscillating program 208, and welding torch amperage program 210.

Computer system 400 can be coupled to one or more input and output devices such as a display 414, a scanner 418, a printer 416, and a mouse 420.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or”herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

Some portions of the detailed descriptions are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. An arc welding system for welding materials of different electric conductivity, the system comprising:
a robotic arm;
a welding torch, having a nozzle, disposed on a first end of the robotic arm, for applying an amperage to a wire supply at the nozzle;
a controller for controlling direction and speed of movement of the robotic arm and for controlling the amperage applied by the welding torch, the controller comprising one or more processors, one or more computer-readable tangible storage devices, and program instructions stored on at least one of the one or more storage devices for execution by at least one of the one or more processors, the program instructions comprising:
program instructions configured to cause the robotic arm to move the first end in a first direction along a seam between a first base material having a first electric conductivity and a second base material having a second electric conductivity different from the first electric conductivity;
program instructions configured to cause the robotic arm to oscillate the first end between a first region proximate to the first base material and a second region proximate to the second base material; and
program instructions configured to cause the welding torch to apply a first amperage to the wire supply when the first end of the robotic arm is proximate to the first region, and to apply a second amperage, different from the first amperage, to the wire supply when the first end of the robotic arm is proximate to the second region.

2. The system of claim 1, wherein the first base material is copper and the second base material is steel.

3. The system of claim 1, wherein the program instructions configured to cause the robotic arm to move the first end in a first direction along the seam and the program instructions configured to cause the robotic arm to oscillate the first end are executed in combination, thereby causing the robotic arm to move in a weave pattern having a plurality of peaks in the first region and a plurality of troughs in the second region.

4. The system of claim 3, further comprising program instructions, stored on at least one of the one or more storage devices for execution by at least one of the one or more processors, configured to cause the first end of the robotic arm to pause at each of the plurality of peaks and to pause at each of the plurality of troughs during oscillation.

5. The system of claim 3, wherein the program instructions configured to cause the robotic arm to oscillate the first end, causes the first end of the robotic arm to oscillate smoothly between each peak and trough without pause.

6. The system of claim 3, wherein the program instructions configured to cause the welding torch to apply a first amperage to the wire supply when the first end of the robotic arm is proximate to the first region, and to apply a second amperage, different from the first amperage, to the wire supply when the first end of the robotic arm is proximate to the second region, causes the welding torch to apply the first amperage when the first end of the robotic arm reaches each of the plurality of peaks and causes the welding torch to apply the second amperage when the first end of the robotic arm reaches each of the plurality of troughs.

7. The system of claim 3, wherein the program instructions configured to cause the welding torch to apply a first amperage to the wire supply when the first end of the robotic arm is proximate to the first region, and to apply a second amperage, different from the first amperage, to the wire supply when the first end of the robotic arm is proximate to the second region, causes the welding torch to gradually change applied amperage as the robotic arm moves from a peak to a trough such that the applied amperage reaches the first amperage when the first end of the robotic arm reaches each of the plurality of peaks and causes the welding torch to gradually change the applied amperage such that the applied amperage reaches the second amperage when the first end of the robotic arm reaches each of the plurality of troughs.

8. The system of claim 1, further comprising program instructions, stored on at least one of the one or more storage devices for execution by at least one of the one or more processors, configured to cause the welding torch to feed the wire supply to the nozzle at a first speed when the welding torch is in the first region, and configured to cause the welding torch to feed the wire supply to the nozzle at a second speed when the welding torch is in the second region.

9. A computer-implemented method of welding materials of different electric conductivity, the method comprising the steps of:
a computer instructing a robotic arm comprising a welding torch to move the welding torch in a first direction along a seam between a first base material having a first electric conductivity and a second base material having a second electric conductivity different from the first electric conductivity;
the computer instructing the robotic arm to oscillate the welding torch between a first region proximate to the first base material and a second region proximate to the second base material; and
the computer causing the welding torch to apply a first amperage to a wire supply when the welding torch is proximate to the first region, and to apply a second amperage, different from the first amperage, to the wire supply when the welding torch is proximate to the second region.

10. The method of claim 9, wherein the computer instructs the robotic arm to move in the first direction at the same time that the computer instructs the robotic arm to oscillate.

11. The method of claim 9, further comprising the step of the computer instructing the robotic arm to pause the oscillation at selected locations.

12. The method of claim 9, further comprising the step of the computer causing the welding torch to gradually change applied amperage from the first amperage to the second amperage.

13. The method of claim 12, further comprising the step of the computer causing the welding torch to gradually change applied amperage from the second amperage to the first amperage.

14. The method of claim 9, further comprising the step of the computer causing the welding torch to feed the wire supply to the nozzle at a first speed when the welding torch is in the first region, and the computer causing the welding torch to feed the wire supply to the nozzle at a second speed when the welding torch is in the second region.

15. An apparatus for welding materials of different electric conductivity, the apparatus comprising:
a robotic arm;
a welding torch, having a nozzle, disposed on a first end of the robotic arm, for applying an amperage to a wire supply at the nozzle;
movement means to move the first end in a first direction along a seam between a first base material having a first electric conductivity and a second base material having a second electric conductivity different from the first electric conductivity;
oscillating means to oscillate the first end between a first region proximate to the first base material and a second region proximate to the second base material; and
amperage means to apply a first amperage, via the welding torch, to the wire supply when the first end of the robotic arm is proximate to the first region, and to apply a second amperage, different from the first amperage, via the welding torch, to the wire supply when the first end of the robotic arm is proximate to the second region.
